(19) United States
(12) Patent Application Publication
(10) Pub. No.: US 2013/0181445 A1
(43) Pub. Date: Jul. 18, 2013

(54) FITTING FOR JACKETED CONDUITS

(71) Applicant: Swagelok Company, Solon, OH (US)

(72) Inventors: William H. Glime, Chagrin Falls, OH (US); Branden Keeper, Mentor, OH (US); Yancy James Waller, Painesville, OH (US); Cory Cottrill, Kent, OH (US)

(73) Assignee: Swagelok Company, Solon, OH (US)

(21) Appl. No.: 13/741,635

(22) Filed: Jan. 15, 2013

Related U.S. Application Data
(60) Provisional application No. 61/587,255, filed on Jan. 17, 2012.

(51) Int. Cl. F16L 15/04

(52) U.S. Cl. CPC F16L 15/04
USPC 285/337

(57) ABSTRACT

A conduit fitting includes a conduit connecting device, a jacket sealing device, and a venting device. The conduit connecting device grips and seals against an unjacketed portion of a metal conduit when the conduit connecting device is assembled on the metal conduit. The jacket sealing device can be joined with at least one of the metal conduit and the conduit connecting device to seal against a jacketed portion of the metal conduit, to at least partially define a cavity between the conduit connecting device and the jacketed portion of the conduit. The venting device is configured to move from a sealing position to a venting position to vent pressure in the cavity.

### RELATED APPLICATION

This application claims the benefit of pending U.S. provisional patent application Ser. No. 61/587,255 filed on Jan. 17, 2012, for FITTING FOR JACKETED CONDUITS, the entire disclosure of which is fully incorporated herein by reference.

### TECHNICAL FIELD OF THE INVENTIONS

The present disclosure relates to fittings for making mechanically attached connections between a conduit and another fluid component, for containing liquid or gas fluids. More particularly, the disclosure relates to fittings for jacketed conduits.

### SUMMARY OF THE DISCLOSURE

In accordance with an embodiment of one or more of the inventions presented in this disclosure, a conduit fitting includes a conduit connecting device, a jacket sealing device, and a venting device. The conduit connecting device grips and seals against an unjacketed portion of a metal conduit when the conduit connecting device is assembled on the metal conduit. The jacket sealing device can be joined with at least one of the metal conduit and the conduit connecting device to seal against a jacketed portion of the metal conduit, to at least partially define a cavity between the conduit connecting device and the jacketed portion of the conduit. The venting device is configured to move from a sealing position to a venting position to vent pressure in the cavity.

In still another exemplary embodiment, a method is contemplated for making a mechanical connection to a jacketed metal conduit having an unjacketed portion. In the exemplary method, a fitting is attached to the unjacketed portion of the metal conduit. A sealing element is compressed in sealing engagement with a jacketed portion of the metal conduit, thereby forming both a fluid-tight seal against the jacketed portion to protect the unjacketed portion of the metal conduit and a cavity at least partially defined by the sealing element. A cavity venting seal is effected, such that pressure in the cavity is vented past the cavity venting seal.

In another exemplary embodiment, a conduit fitting assembly includes a metal conduit having a jacketed portion and an unjacketed portion, a conduit connecting device, a jacket seal, a vent, and a vent seal. The conduit connecting device is assembled on the metal conduit, with the conduit connecting device gripping and sealing against the unjacketed portion of the metal conduit. The jacket seal is joined with at least one of the metal conduit and the conduit connecting device to seal against the jacketed portion of the metal conduit, with a cavity formed between the conduit connecting device and the jacketed portion of the conduit. The vent seal moves to a position that vents pressure in the cavity through the vent when the vent seal is under pressure from the pressure in the cavity.

### BRIEF DESCRIPTION OF THE DRAWING

The drawings illustrate various embodiments of fitting assemblies, wherein:

FIG. 1 illustrates an embodiment of a fitting assembly, shown in longitudinal cross-section, that provides both a mechanical connection to a metal conduit end portion, and a moisture-tight seal against a protective covering of the conduit;

FIG. 2 illustrates an embodiment of a fitting assembly, shown in longitudinal cross-section, utilizing a jacket sealing device including a nut and grommet;

FIG. 3 illustrates an embodiment of a fitting assembly, shown in longitudinal cross-section, utilizing a jacket sealing device including a nut and O-ring seal;

FIG. 4 illustrates an embodiment of a fitting assembly, shown in longitudinal cross-section, utilizing a jacket sealing device including a male-threaded nut and O-ring seal;

FIG. 5 illustrates an embodiment of a fitting assembly, shown in longitudinal cross-section, utilizing a jacket sealing device including an O-ring seal axially squeezed between a jacket end portion and a fitting nut;

FIG. 6A illustrates an embodiment of a fitting assembly, shown in longitudinal cross-section, that provides a mechanical connection to a metal conduit end portion, a moisture-tight seal against a protective covering of the conduit, and a venting arrangement for releasing pressurized fluid contained by the moisture-tight seal;

FIG. 6B illustrates the fitting assembly of FIG. 6A, shown in longitudinal cross-section in a pressurized venting condition;

FIG. 7A illustrates an embodiment of a fitting assembly, shown in longitudinal cross-section, utilizing a venting seal assembled between a fitting nut and seal nut;

FIG. 7B illustrates the fitting assembly of FIG. 7A, shown in longitudinal cross-section in a pressurized venting condition;

FIG. 8A illustrates a side view of the fitting assembly of FIG. 7A, shown with the seal nut in a loosely assembled condition;

FIG. 8B illustrates a side view of the fitting assembly of FIG. 7A, shown with the seal nut in a tightened condition;

FIG. 9 illustrates a perspective view of the fitting nut of the fitting assembly of FIG. 7A;

FIG. 10A illustrates an embodiment of a fitting assembly, shown in longitudinal cross-section, utilizing a seal cartridge assembled between a fitting nut and seal nut;

FIG. 10B illustrates the fitting assembly of FIG. 9A, shown in longitudinal cross-section in a pressurized venting condition;

FIG. 11 illustrates a perspective view of the seal cartridge member of the fitting assembly of FIG. 10A;

FIG. 12A illustrates an embodiment of a fitting assembly, shown in longitudinal cross-section, utilizing a spring-biased sleeve assembled between a fitting nut and seal nut;

FIG. 12B illustrates the fitting assembly of FIG. 12A, shown in longitudinal cross-section in a pressurized venting condition;

FIG. 13 illustrates a perspective view of the sleeve member of the fitting assembly of FIG. 12A; and

FIG. 14 illustrates an embodiment of a fitting assembly, shown in longitudinal cross-section, utilizing a jacket sealing and venting device including an O-ring seal, shown radially expanded in a pressurized venting condition.

### DESCRIPTION OF THE EXEMPLARY EMBODIMENTS

Although the exemplary embodiments herein are presented in the context of a stainless steel tube fitting, the inventions herein are not limited to such applications, and will find use with many different conduits such as tube and pipe as well as different materials other than 316 stainless steel, for example, copper, including different metals for either the conduit, the gripping devices or the fitting components or any combination thereof. The inventions may also be used for liquid or gas fluid systems. While the inventions herein are illustrated with respect to particular designs of the jacket sealing devices, conduit gripping devices and fitting components, the inventions are not limited to use with such designs, and will find application in many different fitting designs that use one or more conduit gripping devices. In the drawings, various gaps and spaces between parts (for example, gaps between the ferrules and the conduit in a finger-tight position) may be somewhat exaggerated for clarity or due to scale of the drawings. Although we describe the exemplary embodiments in terms of “jacketed tubing,” the inventions are not limited to tubing but may be used with any conduit including pipe. Therefore the word “tubing” herein is used only as an example of one type of conduit with which the inventions may be utilized. The inventions also are not limited to conduits that may fall within the common understanding of the terms “jacket” and “jacketed,” rather the terms jacket and jacketed are used for convenience to refer to any protective sheath, cover, treatment or coating, and to any metal conduit having a protective sheath, cover, treatment or coating about its exterior surface, especially protective layer or layers for anticorrosion protection.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

With reference to the drawings, several embodiments of the inventions are presented. All references herein to “radial” and “axial” are referenced to the X axis, as shown in the drawings, except as may otherwise be noted. Also, all references herein to angles are referenced to the X axis except as may otherwise be noted.

“Devices,” as described herein, may include one or more integral, assembled, and/or operatively associated components that operate to perform a function for a described apparatus. A device may include portions that are integral to or assembled with other components or devices of the apparatus.

External corrosion of metal tubing can negatively impact the performance of tubing installations. Although corrosion resistant tubing may be used, such tubing is usually of higher cost which can be a significant factor for systems that use long and extensive tubing runs. As a lower cost alternative to corrosion resistant tubing, a protective polymer or elastomer layer, commonly known as a jacket, is applied over standard, less expensive tubing. The jacket may be formed onto the tubing such as by extrusion or receive the tubing such as with a slip fit, shrink-fit, spray-on, dip-coat, etc., to name a few examples. The protective jacket, which is also referred to herein as a protective layer, coating, cover or sheath, may be made of any suitable material, with polyvinylchloride (PVC) and thermoplastic urethane (TPU) being in common use today, but other materials may be used including but not limited to PFA and PTFE. The jacket is used to provide a water proof or moisture proof barrier to inhibit corrosion, for example crevice corrosion, that might otherwise occur due to environmental exposure, particularly marine environments, for example. Jacketed tubing may be used with mechanical connections such as ferrule type tube fittings, but in order to make the mechanical connection, the jacket must be cut away, pulled back, or otherwise absent from the tube end or other portion where the mechanical connection is to be made in order for the ferrules (or other such conduit gripping devices) to properly grip and seal the tubing. In the past, the exposure of the end portion of the tubing for fitting make-up further necessitated adding a heat shrink material or an adhesive material such as silicon tape to the exposed tube end after the mechanical connection was completed. The use of shrink wrap material or self adhesive tape have numerous disadvantages, particularly for post-installation activities. The present disclosure is directed to better designs and methods for protecting the exposed tubing where the protective jacket has been removed, for example, to allow a mechanical connection to be made to the tubing without compromising the corrosion resistance of the jacketed tubing.

The present disclosure contemplates fitting assemblies that provide both a mechanical connection to an unjacketed or exposed portion of a metal tube end, and a moisture-tight seal against a protective covering or jacket of the tubing to seal the unjacketed portion of the tubing from external moisture and other contaminants. According to an aspect of the present disclosure, a fitting assembly may include a tube fitting component and a jacket sealing device that seals against an outer surface of the jacket when the jacket sealing device is assembled with the tube fitting component. In one embodiment, a jacket sealing device is configured to be assembled with a fitting nut to provide a moisture-tight seal between the fitting nut, the jacket sealing device, and the tubing jacket.

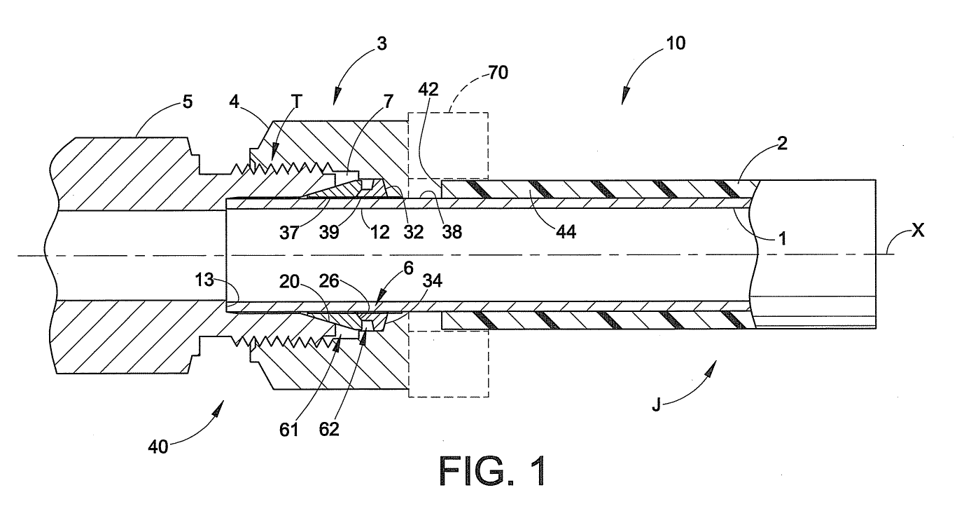

While the inventive aspects of the present disclosure may be utilized with a variety of fittings, in one embodiment, a two-ferrule compression tube fitting is provided with a jacket sealing device for preventing exposure to moisture of an uncovered or unjacketed portion of a tube (which may, but need not, be the endmost portion of the tube) with which the fitting is assembled. In the exemplary embodiment of FIG. 1, a fitting assembly 10 is provided for jacketed tubing J. The jacketed tubing J includes a metal tube 1 and a protective coating or sheath 2, also commonly referred to as a jacket. The jacket 2 may be made of any suitable material including but not limited to PVC and TPU, and may be applied to the metal tube 1 by any suitable process as is well known in the art. Jacketed tubing is commercially available from different tubing suppliers. The metal tube may be provided in any metal that is convenient for a particular installation, including but not limited to stainless steel and copper.

The fitting assembly 10 may include a first coupling or fitting component 3 having a first end or end connection 4 that is joinable to a second coupling or fitting component 5. These parts are commonly known in the art as a nut and body respectively, wherein the body 5 receives a tube end portion, and the nut end connection 4 may be joined to the body 5 during make up of the fitting. Although we use the common terms of body and nut herein as a convenience, those skilled in the art will appreciate that the inventions are not limited to applications wherein such terminology may be used to describe the parts. The body 5 may be a stand-alone component as illustrated or may be integral with or integrated or assembled into another component or assembly such as, for example, a valve, a tank or other flow device or fluid containment device. The body 5 may have many different configurations, for example, a union, a tee, an elbow and so on to name a few that are well known in the art. Although the body 5 and the nut end connection 4 are illustrated as being threadably joined together by a threaded connection T, threaded connections are not required in all uses. For example, some fittings have parts that are clamped together to give one example. Fittings are also commonly referred to in the art as male fittings or female fittings, with the distinction being that for a male fitting the body includes an externally male threaded portion and the nut includes an internally female threaded portion. For a female fitting, the nut includes an externally male threaded portion and the body includes an internally female threaded portion. The exemplary embodiments herein illustrate a male fitting assembly embodiment, for example, but the inventions may be conveniently adapted for use with a female fitting assembly.

The mechanical body-nut connection 40 of the fitting 10 may be used to form a fluid-tight connection between an end portion 12 of the tubing 1 and the body 5 using one or more conduit gripping devices 6, which in the exemplary embodiments herein may be realized in the form of one or more ferrules 6, including in this embodiment a front ferrule 61 and a back ferrule 62. However, conduit gripping devices other than those that may be understood in the art as ‘ferrules’ may also be used with the inventions herein. The tubing 1 typically bottoms against a radial shoulder that is part of the body 5, and is well known. The body 5 includes a camming surface 20 that engages the front portion of the front conduit gripping device or ferrule 61. The front ferrule 61 includes a camming surface 26 at its back or outboard end that engages a front portion of a second or back conduit gripping device or ferrule 62. The back ferrule 62 includes a driven surface 32 that engages a drive surface 34 of the female nut 4. The front and back ferrules include cylindrical interior walls 37, 39 that are closely received over the outer surface 38 of the tubing 1 and within a cavity 7 formed by the nut 4 and body 5. Although the exemplary embodiments herein illustrate fitting assemblies that use a conduit gripping device or ferrule set having two conduit gripping devices or ferrules, the inventions will readily find application to fittings that may use only a single conduit gripping device, as well as fittings that may use ferrule sets having more than two conduit gripping devices, or additional parts other than just ferrules or conduit gripping devices, for example, additional seals.

The body 5, end connection portion 4 of the nut 3 and the ferrules 6 thus form a mechanical connection 40 that is well known and commonly used for as a flareless tube end connection to provide a grip and seal against the outer metal surface of the tubing 1. In order for the mechanical connection 40 to work properly, the protective jacket 2 is removed or otherwise absent from a portion of the tubing 1 that will be used to form the mechanical connection. Thus, the jacket 2 will extend to an end 42, leaving an exposed portion 38 of the tubing 1. The jacket 2 may be assembled or fitted with the tubing 1 so as to terminate at the end 42. Alternatively, an endmost portion of the jacket 2 initially covering the exposed portion 38 may be removed by any convenient technique including cutting or peeling/rolling back the jacket 2.

It is important to note that the exemplary geometric shapes, configurations and designs of the fitting coupling components 4, 5 and the conduit gripping devices 61, 62 are a matter of design choice and will depend in great measure on the materials used, and the design and performance criteria expected of the fitting. Many different coupling components and conduit gripping device designs are known in the art and may be designed in the future, including, for example, flared tubing connections and permanent fitting connections (e.g., Phasetite®).

The term “complete pull-up” and derivative terms as used herein refers to joining the fitting components 4 and 5 together so as to cause the one or more conduit gripping devices 6 to deform, usually but not necessarily plastically deform, to create a fluid-tight seal and grip of the mechanical connection 40 on the tubing 1. A “partial pull-up” and derivative terms as used herein refers to a partial but sufficient tightening of the male and female fitting components together so as to cause the conduit gripping device or devices to deform so as to be radially compressed against and thus attached to the tubing, but not necessarily having created a fluid-tight connection or the required grip that is achieved after a complete pull-up. The term “partial pull-up” thus may also be understood to include what is often referred to in the art as pre-swaging wherein a swaging tool is used to deform the ferrules onto the tubing sufficiently so that the ferrules and the nut are retained on the tubing prior to being mated with the second fitting component to form a fitting assembly. A finger tight position or condition refers to the fitting components and conduit gripping devices being loosely assembled onto the tubing but without any significant tightening of the male and female fitting components together, usually typified by the conduit gripping device or devices not undergoing plastic deformation. The drawings herein show the mechanical connection 40 in a finger-tight condition prior to final tightening and pull-up.

FIG. 1 illustrates the mechanical connection or conduit connecting device 40 in a finger-tight position, meaning that the various parts including the fitting body 5, fitting nut 3, and ferrules 61, 62 have been manually assembled onto the tubing 1 but are loosely assembled or slightly tightened or snugged up by manually joining the nut 3 and body 5 together. Fittings are commonly pulled-up to a complete pulled-up position by counting complete and partial turns of the nut 3 relative to the body 5 from the finger-tight position. The present inventions, however, may be used with fitting designs that alternatively may be pulled-up by torque. Examples of fitting designs that may be pulled-up by torque are described in U.S. Pat. No. 7,695,027, the entire disclosures of which are incorporated herein by reference.

In order to effect complete grip and seal, the nut end connection 4 and body 5 are tightened together—commonly known in the art as pull-up or pulling up the fitting and derivative terms—such that the back ferrule 62 and front ferrule 61 axially advance against their respective camming surfaces 26 and 20. This causes a radially inward compression of the ferrules against the outer metal surface of the tubing 1 to effect grip and seal. In the exemplary fitting assembly herein, grip is primarily achieved with the back ferrule, with the front ferrule primarily providing a fluid-tight seal. However, in some designs the front ferrule may also grip the tubing and the back ferrule may also provide a fluid-tight seal. Thus, the term “conduit gripping device” may include two distinct functions, namely grip and seal, whether or not a specific conduit gripping device performs one or both of those functions. The present inventions may alternatively be used with single conduit gripping device style fittings in which a single conduit gripping device performs both the grip and seal functions, and still further alternatively may be used with fittings that use more than two conduit gripping and sealing devices. Although not limiting the scope of the present inventions, the exemplary fitting design illustrated herein is of a type well known and commercially available from Swagelok Company, Solon, Ohio. Examples of such fittings that may be provided with one or more of the inventive features of the present disclosure are described in a number of issued and pending patent applications, including U.S. Pat. Nos. 5,882,050 and 6,629,708, which describe a two-ferrule fitting with a rear ferrule having a geometry designed to reduce galling, localized loading, and torque forces, the entire disclosures of which are fully incorporated herein by reference.

To provide a moisture-tight seal over the exposed portion 38 of the tubing 1, the fitting 10 of FIG. 1 includes a jacket sealing device, represented schematically at 70, that effects a seal between the nut 3 and the jacket 2. As described and shown in the several exemplary embodiments described herein, some or all of the jacket sealing device 70 may be integral with the nut 3 and/or may include one or more components configured to assemble with or seal against the nut 3. In some embodiments, the jacket sealing device 70 may include a single component that provides both mechanical attachment to the nut 3 and sealing engagement with the nut and jacket. In other embodiments, the jacket sealing device 70 may include a seal engaging member (e.g., a fastening member, such as a nut or clamp) and a separate sealing element (e.g., an O-ring, gasket, or grommet). The sealing element may include a first portion that seals against the nut 3 and a second portion that seals against the jacket 2 to complete a seal over the exposed or unjacketed portion 38 of the tubing 1.

In an exemplary method, a mechanical connection for jacketed tubing is provided, with the method including the steps of attaching a fitting to an unjacketed portion of a metal tube by using a ferrule-type fitting assembly to provide grip and seal against the unjacketed portion of the tube, and securing a sealing member in sealing engagement with the fitting (for example, with the nut) and with a jacketed portion of the tube by joining a seal engaging member with at least one of the fitting nut, fitting body, and metal tube.

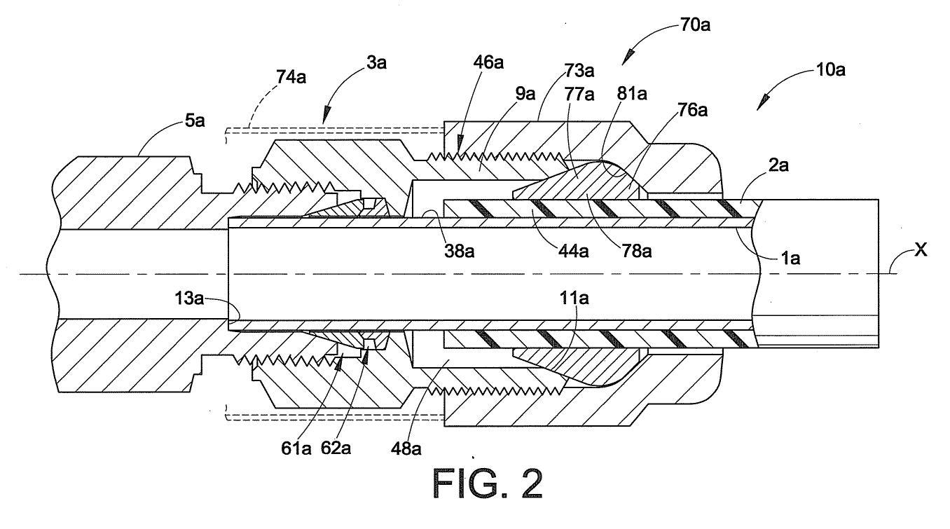

FIG. 2 illustrates an exemplary fitting 10a provided with a jacket sealing device 70a including a seal engaging member 73a for assembly with the fitting nut 3a, and a sealing element 76a having a first portion 77a that seals against the fitting nut 3a and a second portion 78a that seals against an end portion 44a of the jacket 2a. While the fitting nut 3a and fastening member 73a may utilize any suitable mechanical connection, the fitting nut 3a of the illustrated embodiment includes a generally cylindrical extension 9a that is sized to extend over an end portion 44a of the jacket 2a when the tubing 1a has been fully inserted and seated against the body shoulder 13a. The extension 9a mates with female threads of the fastening member 73a, formed as a second nut (or seal nut) or cap, for example, by a threaded connection 46a. The exemplary sealing element 76a is captured in a cavity defined between the jacket portion 44a and an interior wall of the seal nut 73a, and is formed as an elastomeric sleeve or grommet. The seal nut 73a includes an interior wall or drive surface 81a that compresses the sealing element 76a against the outer surface of the jacket 2a when the seal nut 73a is tightened onto the nut extension 9a. The nut extension 9a also may include a tapered or other profile surface 11a that retains the sealing element 76a in the cavity 48a as the sealing element 76a is compressed against the jacket 2a. In this manner, the sealing element 76a forms a fluid-tight seal with the jacket 2a, thus protecting the exposed portion 38a of the tubing 1a, including the portion that is outboard of the ferrules 61a, 62a. Further, the sealing element 76a may additionally form a fluid-tight or moisture tight seal with the tapered nut sealing surface 11a, to further prevent leakage past the threads of the seal nut 73a. Whether the seal formed against the jacket is considered a moisture resistant seal or a fluid-tight seal will depend on the intended application and resistance to fluid and moisture needed, particularly at elevated pressures. In one example, the sealing element 76a may provide a leak-tight seal to 15 bar.

The fitting assembly 10a thus may utilize known or later developed mechanical connections of the flareless tube end variety using one or more conduit gripping devices or ferrules, with a nut that is modified to include a second end that can be mated to a second nut (or seal nut) or cap. While the seal nut 73a may be tightened before the mechanical connection is pulled-up, in some applications, it may be desirable to pull up the mechanical connection before tightening the seal nut, to minimize twisting of the tubing jacket 2a on the tube 1a by the seal nut 73a during pull up.

When disassembling the exemplary fitting 10a, it may be desirable to loosen the seal engaging member or seal nut 73a before loosening the fitting nut 3a, such that the jacket end portion 44a is not twisted on the tubing 1a as the fitting nut 3a is loosened. To impede loosening of the fitting nut 3a while the seal nut 73a remains tightened, the seal nut 73a may be provided with a sleeve or extension, shown schematically at 74a, which covers the hex flats of the fitting nut 3a when the seal nut 73a is tightened. This sleeve 74a may be integral to the seal nut 73a or assembled with the nut (e.g., a plastic sheath). In one embodiment, the sleeve 74a may be removable and/or disposable, such that the sleeve may be removed to make intentional adjustments to the fitting nut 3a and/or the seal nut 73a (for example, allowing an installer to apply one wrench to the fitting nut flats and a second wrench to the seal nut flats to tighten or loosen the seal nut 73a. The sleeve 74a may be provided with text or other indicia notifying the installer that the seal nut 73a should be loosened before loosening the fitting nut 3a.

The sealing element may be provided in many different suitable geometries and materials. In one embodiment, a fitting nut extension and seal nut may utilize the designs and dimensions of one or more electrical cable gland assemblies known in the art, in combination with a cable gland grommet or a seal member resembling a cable gland grommet utilized as a sealing element between a jacket end portion and the fitting nut. In the embodiment of FIG. 2, the fitting nut extension 9a and seal nut 73a may be provided with thread and sealing geometries described in German patent publication DE 10 2004 061 488 A1, and the sealing element 76a may be provided with a geometry consistent with grommets described in German patent publication DE 20 2005 005 320 U1, the entire disclosures of both of which are incorporated herein by reference. The sealing element may be provided in a suitable elastomeric material, such as, for example, any one or more of thermoplastic elastomers, thermosets, Santoprene®, Perbunan®, Tefabloc®, silicone, NBR, nitrile rubber, and neoprene. The shape, size, geometry and material of the sealing element 76a need not be as shown in the drawing, and may be selected to provide the desired seal function to protect the exposed metal portion of the tubing 1a that is outboard of the ferrules 61a, 62a.

While thread engagement between the seal nut 73a and the fitting nut 3a may be sufficient to maintain a sufficiently tight, jacket sealing condition for the jacket sealing device 70a, in other embodiments, a seal nut may be secured in the jacket sealing condition by one or more nut-locking features, including, for example, a counter nut, lock washer, sealant, or other such configuration, for example, to prevent loosening of the seal nut due to system vibrations, thermal cycling, or other such conditions.

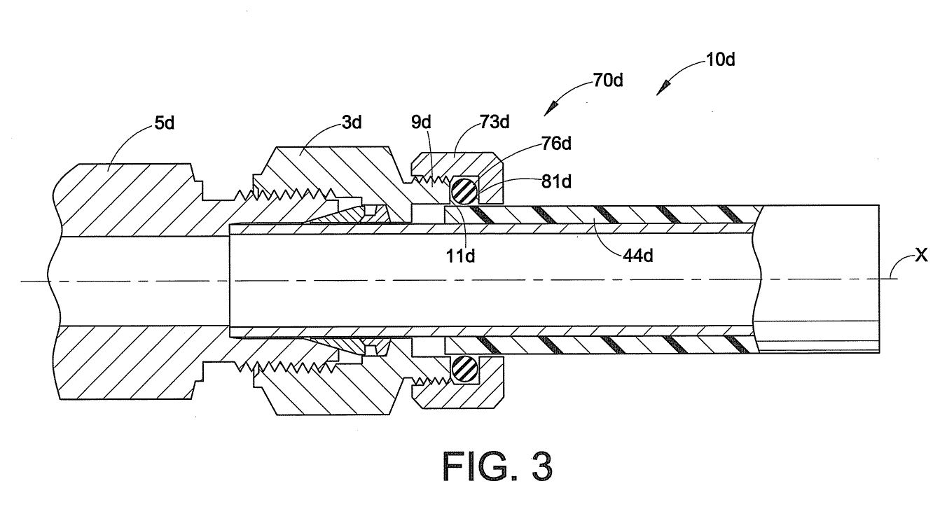

In other embodiments, an O-ring seal may be compressed between a fitting nut and a seal engaging member (e.g., a second nut or seal nut) to seal against the fitting nut and the jacket end portion. FIG. 3 illustrates an exemplary fitting 10d that includes a second nut or seal nut 73d for assembly with a threaded extension 9d of a fitting nut 3d, and an O-ring seal 76d that is axially compressed between a sealing surface 11d of the fitting nut 3d and a drive surface 81d of the seal nut 73d to seal against the jacket end portion 44d. One or both of the sealing surface 11d and drive surface 81d may be tapered to facilitate radial inward compression of the O-ring seal 76d when the seal nut 73d is tightened with the fitting nut 3d.

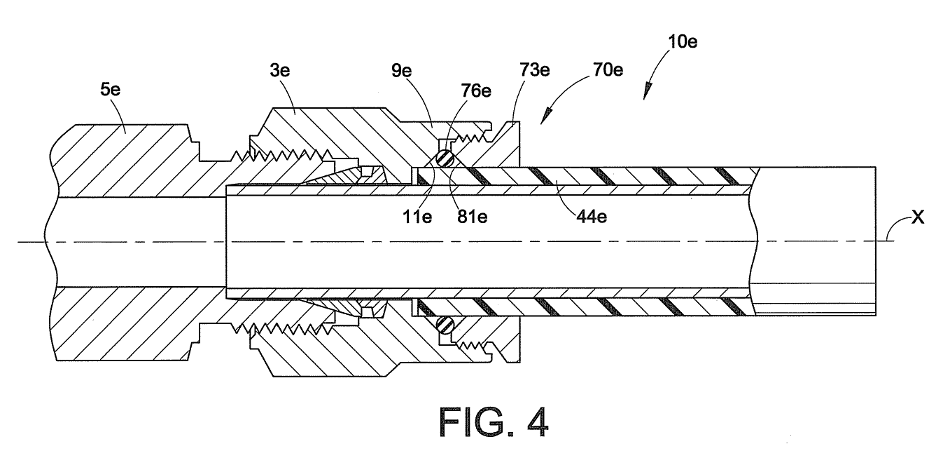

FIG. 4 illustrates an exemplary fitting 10e that includes a male threaded second nut or seal nut 73e for assembly with a female threaded extension 9e of the fitting nut 3e, and an O-ring seal 76e that is axially compressed between a sealing surface 11e of the fitting nut 3e and a drive surface 81e of the seal nut 73e to seal against the jacket end portion 44e. One or both of the seal surface 11e and drive surface 81e may be tapered to facilitate radial inward compression of the O-ring seal 76e when the seal nut 73e is tightened with the fitting nut 3e.

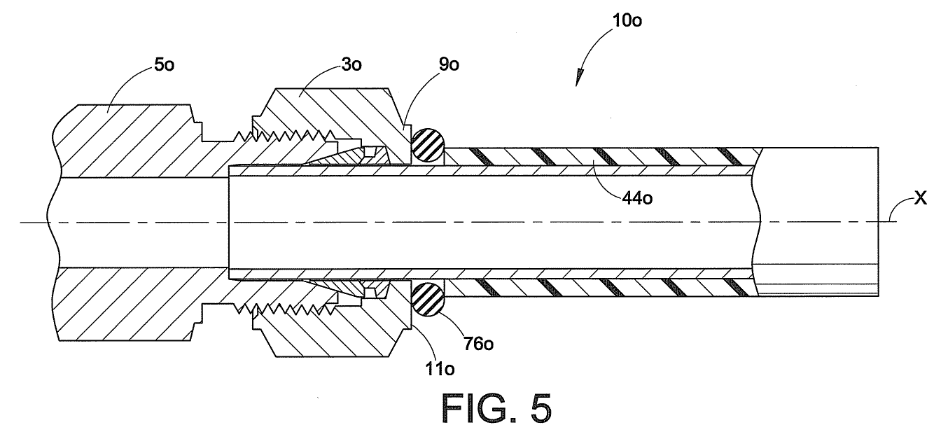

Other types of sealing elements may be provided to seal directly with a fitting nut. For example, as shown in FIG. 5, an O-ring seal 76o may be wedged or axially squeezed or compressed between a jacket end portion 44o and an installed fitting nut 3o to provide a seal between the jacket end portion 44o and an end face 11o of the fitting nut 3o.

Many other alternative jacket sealing arrangements are described in co-pending U.S. application Ser. No. 13/051,211 (U.S. App. Pub. No. 2011/0227337, or the “'337 Application”) and PCT Application No. PCT/US11/28967 (Pub. No. WO 2011/116271), each entitled FITTING FOR JACKETED TUBING and filed on Mar. 18, 2011, and each claiming priority to U.S. Provisional Application Ser. No. 61/315,202, entitled FITTING FOR JACKETED TUBING and filed on Mar. 18, 2010, the entire disclosures of each of which are incorporated by reference herein.

According to another aspect of the present disclosure, a fitting assembly utilizing a jacket sealing device (for example, a jacket sealing device consistent with one or more of the jacket sealing devices of FIGS. 1-5, described above, or with one or more of the jacket sealing devices of the above incorporated '337 Application) may conceal or retain pressurized fluid past the fitting connection, such that pressurized fluid is trapped in a cavity between the fitting nut and the jacket sealing device. As the pressure in this cavity builds, the fluid may leak or pass between the tubing and the protective jacket, exposing jacketed portions of the tubing to damage (e.g., splitting or separation of the jacket) and possible corrosion. This leakage, being contained by the tubing jacket, may be difficult to detect until damage to the jacket has already occurred.

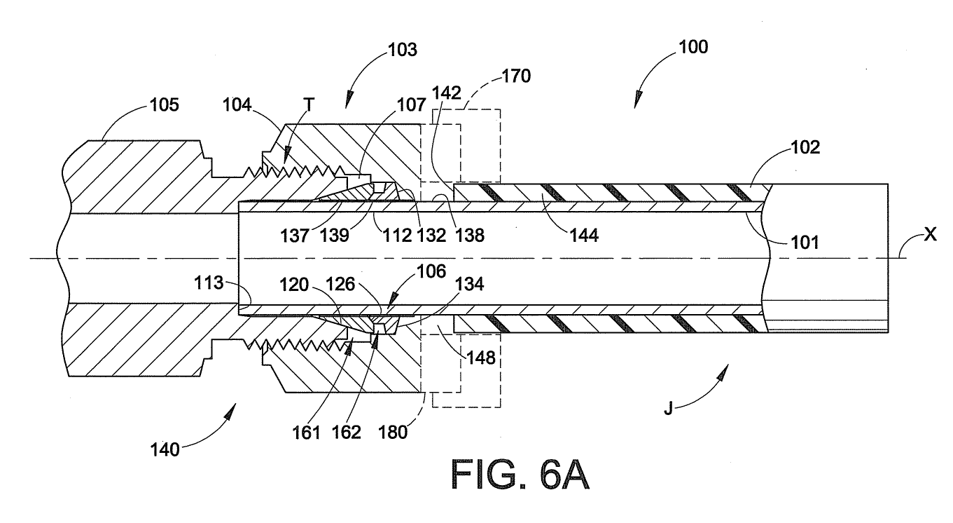

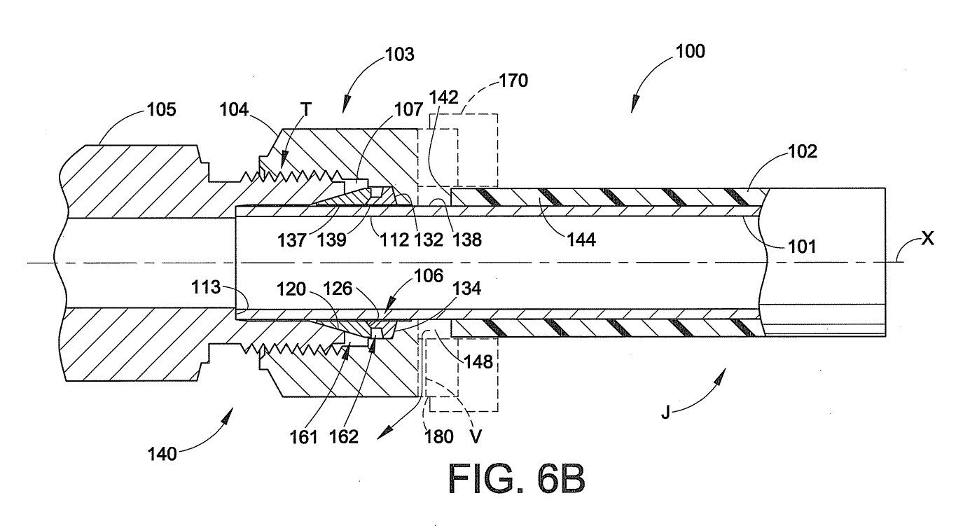

In an exemplary embodiment of the present application, as illustrated in FIGS. 6A and 6B, a fitting assembly 100 with a jacket sealing device (shown schematically at 170) for sealing against a jacket end portion 144 of a jacketed tube J additionally includes a venting device (shown schematically at 180) configured to vent pressure in a cavity 148 (e.g., pressurized fluid trapped in the cavity) between the fitting nut 103 and the jacket sealing device 170. The venting device 180 may include any arrangement configured to vent pressure (e.g., some or all of the positive pressure in the cavity), for example, through a vent path V, as schematically shown in FIG. 6B. This pressure may, for example, be vented to atmosphere, to another portion of the fitting (e.g., a second cavity), or to another device (e.g., a leak detection device), or by expanding the cavity to reduce the pressure in the cavity (effectively venting pressure to portions of the expanded cavity). The vent path V may include any flow path suitable for the release of pressure including, for example, openings, ports, gaps, conduits, and threaded connections. The venting device may, but need not, effect or allow for a seal against ingress of external contaminants, for example to further protect the unjacketed portion of the tube from contamination or corrosion. The seal against ingress of contamination may prevent, impede or reduce the ingress of contamination.

Suitable venting devices may include, for example, radially expandable seals (e.g., O-rings), axially slideable seals (e.g., O-rings, gaskets), check valves, relief valves, and other such arrangements. In exemplary embodiments of the application, some or all of the venting device may be integral to or assembled with one or both of the fitting nut and jacket sealing device of the fitting assembly. The venting device may be configured to vent pressure at any predetermined pressure or range of pressures. For example, the venting device may be configured to open or move to a venting position at a predetermined pressure that moves the venting device to a venting position. In an exemplary embodiment, the venting device is configured to vent at a pressure below a pressure that would result in fluid leakage between the jacket and the conduit, thereby preventing, minimizing, or reducing such leakage. In one example, a venting device is configured to vent at pressures of approximately 1-65 psig.

According to an aspect of the present application, an exemplary conduit fitting may include a conduit connecting device, a jacket sealing device, and a venting device. The conduit connecting device provides a metal connection to an unjacketed portion of a metal conduit when the conduit fitting is assembled on the metal conduit. The jacket sealing device that seals against a jacketed portion of the metal conduit when the conduit fitting is assembled on the metal conduit. The venting device moves from a first position to a venting position to vent pressure in a cavity of the conduit fitting.

In one embodiment, a portion of the fitting assembly defining the seal cavity may be provided with a vent port and a venting seal member that seats against the vent port to seal against ingress of external contaminants, and that moves to release pressurized fluid within a seal cavity through the vent port. In an exemplary embodiment, a vent port in fluid communication with the seal cavity is provided in the fitting nut.

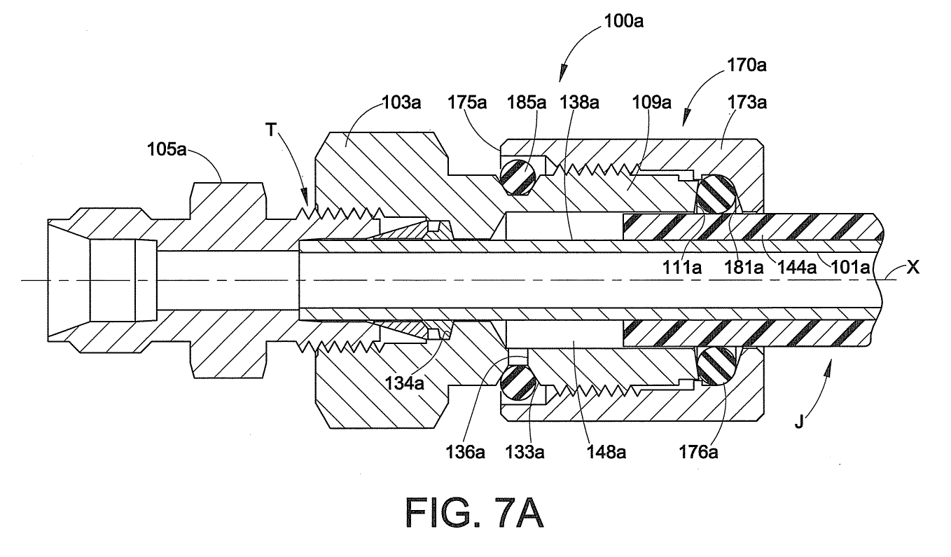

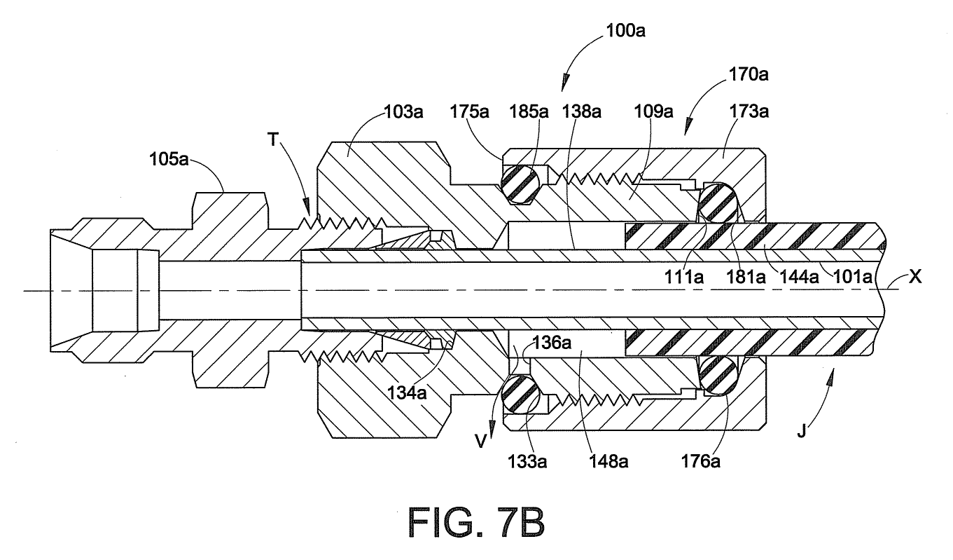

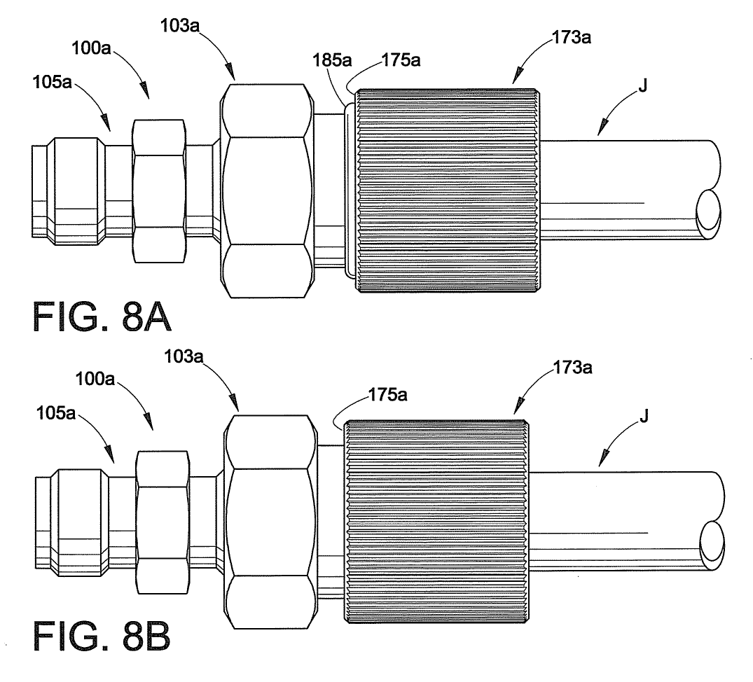

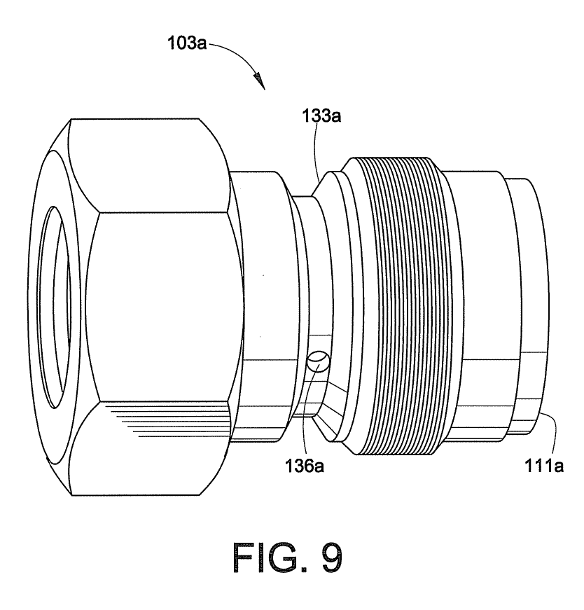

FIGS. 7A-8B illustrate an exemplary embodiment of a fitting assembly 100a having a jacket sealing device 170a that includes a seal nut 173a for assembly with a threaded extension 109a of a fitting nut 103a, and an O-ring seal 176a that is axially compressed between a sealing surface 111a of the fitting nut 103a and a drive surface 181a of the seal nut 173a to seal against the jacket end portion 144a. One or both of the sealing surface 111a and drive surface 181a may be tapered (e.g., frustoconical) to facilitate radial inward compression of the O-ring seal 176a when the seal nut 173a is tightened with the fitting nut 103a.

To allow for venting of pressurized internal fluid trapped within a seal cavity 148a disposed between the fitting nut 103a and the seal nut 173a, one or more vent ports 136a may be provided in the fitting nut 103a between the drive surface 134a and the sealing surface 111a. A radially expandable venting O-ring seal 185a is received around the fitting nut 103a in alignment with the vent port 136a to seal against ingress of external contaminants through the vent port 136a. When pressurized fluid accumulates in the seal cavity 148a, the fluid pressure exerts a force on the venting seal 185a to radially expand the seal and separate the seal from the vent port 136a (as shown in FIG. 7B), allowing pressurized fluid to escape through the vent port. To facilitate seating alignment of the venting seal 185a with the vent port 136a, the fitting nut 103a (more clearly shown in FIG. 9) may be provided with an annular groove 133a over which the venting seal is stretched, allowing the venting seal 185a to constrict against the surfaces of the groove and into sealing engagement with the vent port 136a.

A venting seal member may additionally be utilized to provide a visual indication of proper assembly of the seal nut. For example, as shown in FIGS. 8A and 8B, a jacket seal venting fitting assembly 100a may be configured such that when the seal nut 173a is loosely assembled or under-tightened with the fitting nut 103a, such that a seal between the O-ring seal 176a and the jacket end portion 144a is absent or insufficient, at least a portion of the venting seal 185a is visible beyond the seal nut 173a (as shown in FIG. 8A). When the seal nut has been properly tightened the venting O-ring seal 185a is obscured by an external lip portion 175a of the seal nut 173a, such that absence of any visible portion of the venting seal may provide a visual confirmation of proper installation of the seal nut (as shown in FIG. 8B). The external lip portion 175a may be unthreaded to protect the venting seal from engagement with the seal nut threads.

To assemble the fitting 100a with a jacketed tube end J, a portion of the jacketing is removed from the endmost portion of the tube end J, and a loosely assembled fitting 100a is provided. In one embodiment, the fitting nut 103a, ferrules, O-ring seals 176a, 185a, and seal nut 173a may be maintained as a nut subassembly on a disposable arbor or other retainer (not shown). An example of one such arbor is described in U.S. Pat. No. 7,497,483 to Williams et al., the entire disclosure of which is incorporated herein by reference. When the nut subassembly is assembled with a fitting body 105a, the arbor releases the nut subassembly components (e.g., as a result of inward flexing prongs retaining the ferrules.

The unjacketed portion of the tube end J is inserted into the fitting body 105a of the loosely assembled fitting 100a, and the fitting nut 103a is pulled up on the fitting body 105a (e.g., by measured torque or by counted turns of the nut 103a) to attach the ferrules to the unjacketed portion of the tube end J. The seal nut 173a is then tightened until the external lip portion 175a of the seal nut 173a covers the venting O-ring seal 185a, to provide visual confirmation of sufficient tightening. This tightening of the seal nut axially compresses O-ring seal 176a between the fitting nut extension 109a and the seal nut drive surface 181a, and radially compresses the venting O-ring seal 185a against the jacketed portion of the tube end J to provide a seal between the fitting nut 103a, seal nut 173a and tube jacketing.

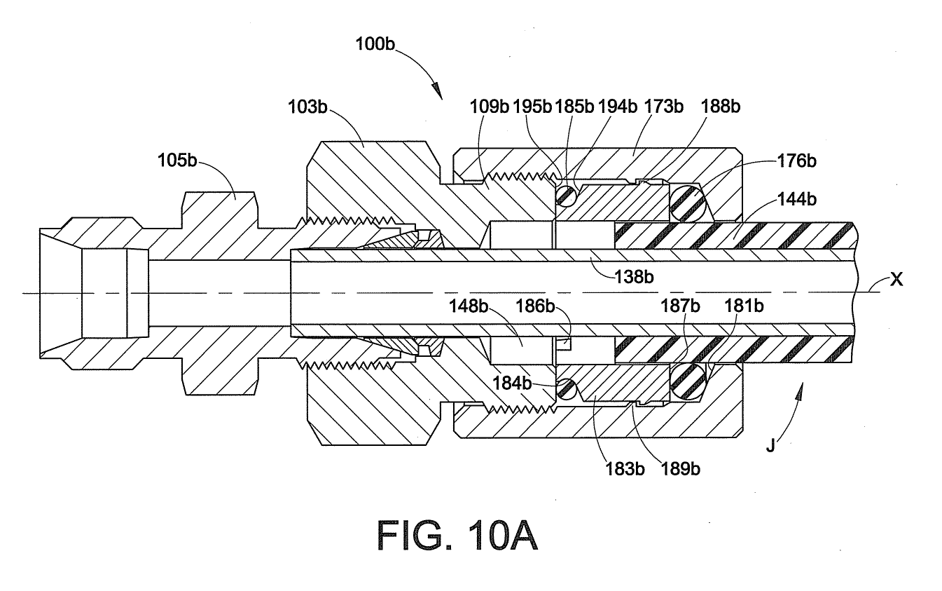

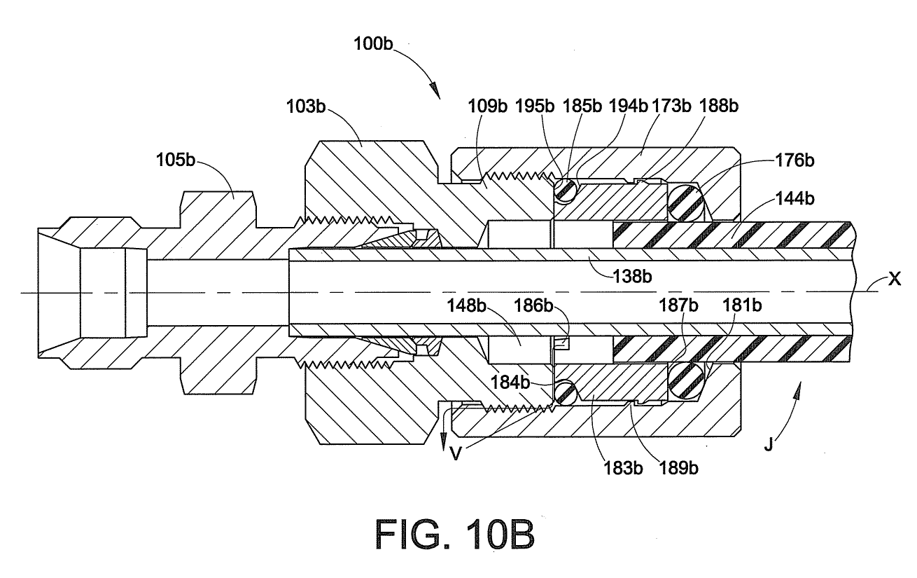

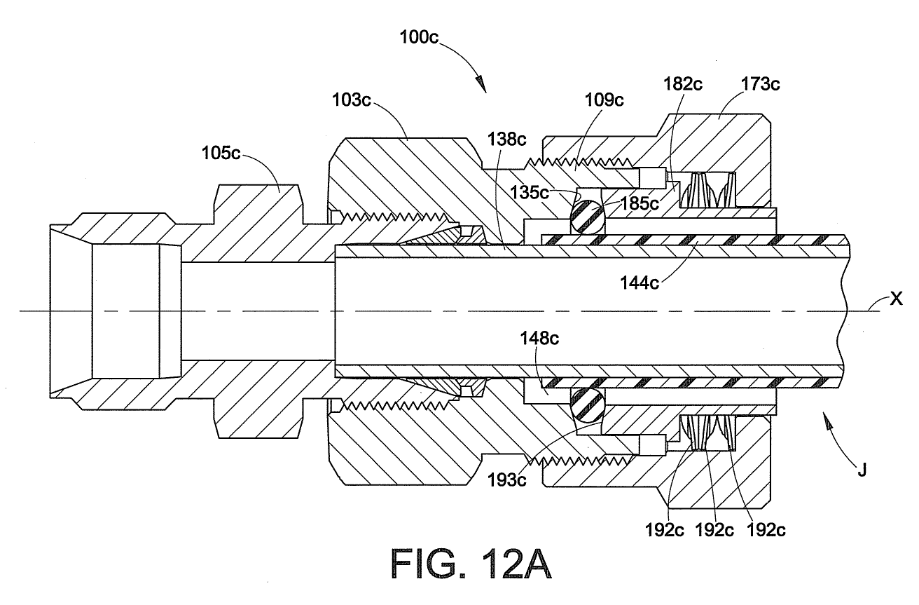

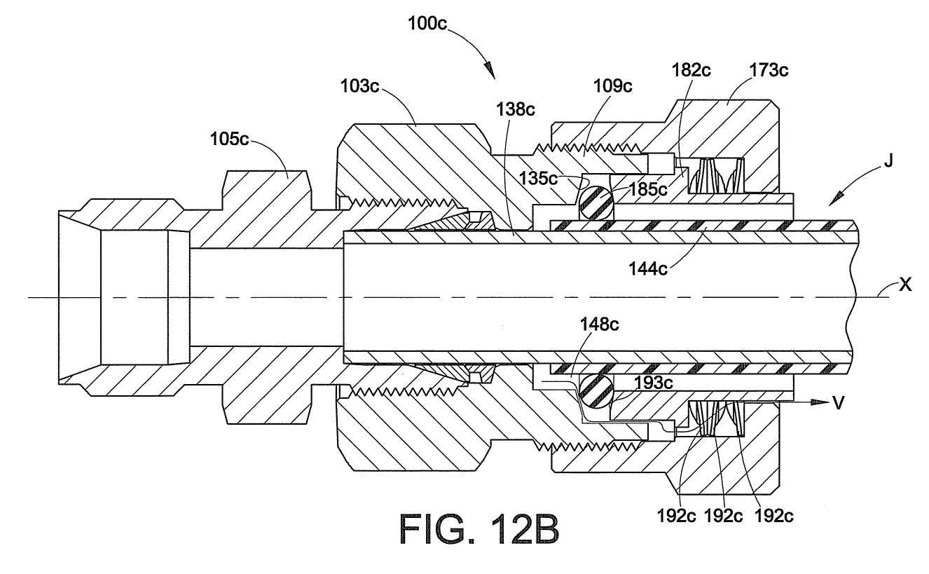

In another exemplary embodiment, a venting insert installed between a fitting nut and a seal nut provides a venting feature for venting pressurized fluid from a seal cavity. The venting insert may be configured to seal against the fitting nut at a first end and to seal against the seal nut at a second end. Additional sealing components may be utilized to provide seals at the first and second ends of the venting insert. In an exemplary embodiment, a venting seal member (e.g., an O-ring), movable in response to internal fluid pressure to allow venting, also effects an environmental seal between the fitting nut and the venting insert at the first end of the insert. In another exemplary embodiment, a jacket sealing member (e.g., an O-ring) provides an environmental seal between the second end of the venting insert and the seal nut over the unjacketed portion of the tube. In still other embodiments (not shown), jacket sealing inserts (such as, for example, inserts similar to the inserts 183b, 182c described below and shown in FIGS. 10A-10B and 12A-12B, respectively) may be provided without the described venting features (e.g., vent openings or spring loaded axial movement), for example, to provide other benefits, such as, for example, allowing for a shorter extended fitting nut or facilitating a self-contained jacket sealing device subassembly.

FIGS. 10A and 10B illustrate an exemplary embodiment of a fitting assembly 100b having a jacket sealing device 170b that includes a seal nut 173b for assembly with a threaded extension 109b of a fitting nut 103b, and a venting insert 183b received between the fitting nut extension 109b and the drive surface 181b of the seal nut 173b. The venting insert 183b includes a retaining groove 184b at a first end sized for a venting O-ring seal 185b to be stretched over an enlarged end of the insert for sealing engagement with notches 186b in the retaining groove 184b. The venting seal 185b is axially compressed between a sealing surface 194b of the venting insert 183b and a sealing surface 195b of the fitting nut 103b to provide an environmental seal between the fitting nut 103b and the venting insert 183b. A jacket sealing O-ring 176b is axially compressed between a second end 187b of the venting insert 183b and the seal nut drive surface 181b, which squeezes the jacket seal 176b against an end portion 144b of the jacket. One or both of the venting insert second end 187b and the drive surface 181b may be tapered (e.g., frustoconical) to facilitate radial inward compression of the O-ring seal 176b when the seal nut 173b is tightened with the fitting nut 103b.

When pressurized fluid accumulates in the seal cavity 148b, the fluid pressure exerts a force through the notches 186b on the venting seal 185b to radially expand the seal and separate the seal from at least one of the fitting nut and insert sealing surfaces 195b, 194b, allowing pressurized fluid to escape past the seal nut threads. In another embodiment (not shown), the seal nut 173b may be provided with a vent port to provide an additional or alternative vent path for the pressurized fluid.

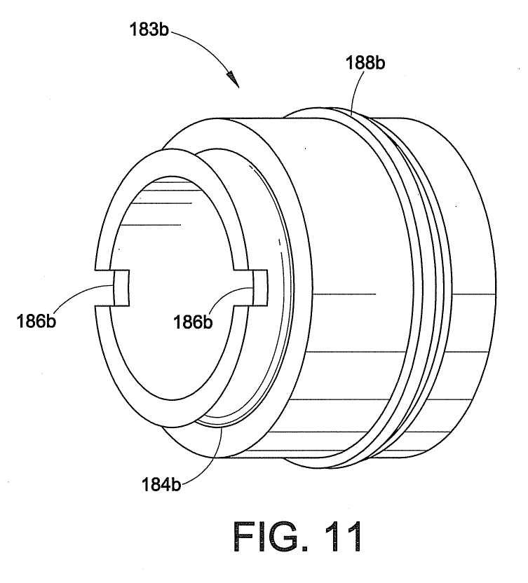

While the venting insert may be provided in any suitable material, in one embodiment, the venting insert is provided in a plastic material (e.g., polypropylene) to facilitate manufacturing, assembly, and sealing performance. In the illustrated embodiment, the venting insert (more clearly shown in FIG. 11) is provided with an outer ridge 188b or other projection that is deformable to interlock with a corresponding inner ridge 189b or other projection on the seal nut 173b. The retaining groove 184b and the interlocking ridges 188b, 189b allow the seal nut 173b, venting insert 183b, jacket seal 176b, and venting seal 185b to be pre-assembled as a self-contained subassembly for eventual assembly with a fitting nut 103b. In another embodiment (not shown), a non-venting (e.g., provided without notches) cartridge insert may be utilized to provide a seal nut subassembly (e.g., seal nut, cartridge insert, jacket sealing O-ring, and fitting nut-to-insert O-ring seal), for example, to facilitate field installation and/or to allow for a shorter extended fitting nut, which may reduce materials and increase visibility for leak checking prior to assembling the seal nut with the fitting nut.

In another exemplary embodiment, a venting seal may additionally or alternatively be axially moveably in response to seal cavity fluid pressure to vent the fluid pressure. In one such embodiment, the venting seal may be axially spring loaded into sealing engagement with the fitting nut, such that fluid pressure within a seal cavity axially moves the venting seal against the biasing force and out of sealing engagement with the fitting nut to vent the fluid pressure. In still another embodiment, the venting seal may additionally seal against a portion of the tube jacket to additionally function as a jacket seal.

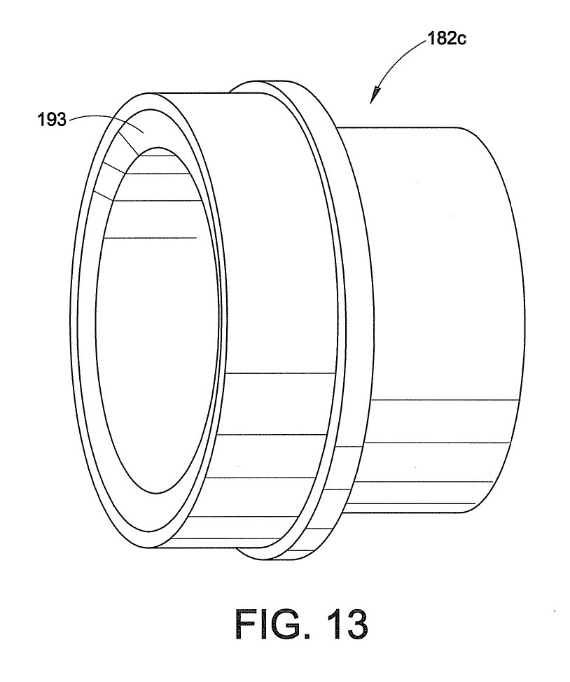

FIGS. 12A and 12B illustrate an exemplary embodiment of a fitting assembly 100c having a jacket sealing device 170c that includes a seal nut 173c for assembly with a threaded extension 109c of a fitting nut 103c, an O-ring seal 185c received in a recessed end cavity 135c of the fitting nut 103c, and a seal loading member or insert 182c installed between the seal nut 173c and the O-ring seal 185c to axially compress the O-ring seal against the recessed cavity 135c and to radially compress the O-ring seal against the jacket end portion 144c. As shown, the seal loading member 182c may be spring loaded into engagement with the O-ring seal 185c by Belleville spring washers 192c. The seal loading member 182c (shown more clearly in FIG. 13) may be provided in metal (e.g., stainless steel), plastic (e.g., polypropylene) or in any other suitable material.

When pressurized fluid accumulates in the seal cavity 148c, the fluid pressure exerts a force on the O-ring seal 185c to axially move the O-ring seal and the seal loading member 182c against the Belleville washers 192c to axially separate the O-ring seal from the sealing surface of the recessed end cavity 135c (as shown in FIG. 12B), allowing pressurized fluid to escape past the seal loading member 182c and Belleville washers 192c. As shown, the tapered or frustoconical end surface 193c of the seal loading member 182c may help maintain an environmental seal between the axially separated O-ring seal and the jacket end portion 144c. In other embodiment (not shown), additional vent ports may be provided in one or more of the fitting nut, seal nut, and seal loading member.

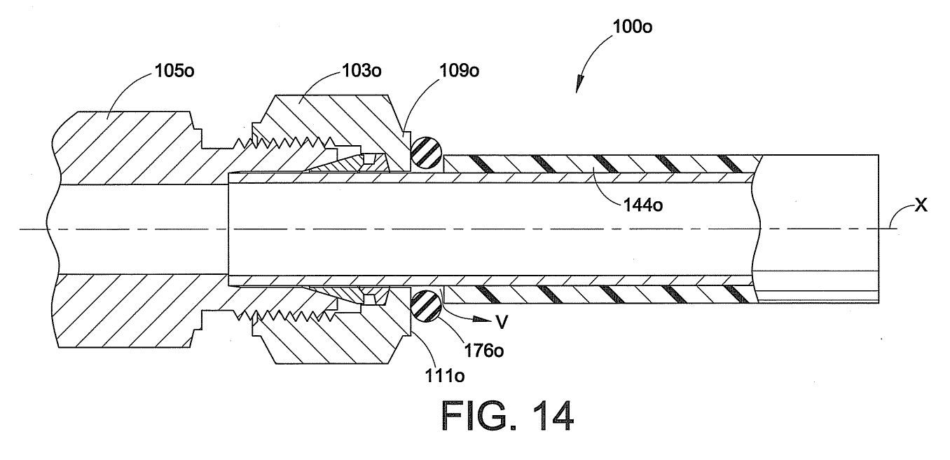

Still other venting devices and arrangements may be used to vent pressure in a cavity between a conduit connecting device and a jacketed portion of a conduit where a seal has been provided between the conduit jacket and the connecting device. For example, a fitting may be provided with a jacket sealing member (e.g., an elastic O-ring, gasket, or sleeve) that both seals against the jacketed portion of the tube end to prevent ingress of contaminants into a cavity between the fitting and the jacketed portion, and is expandable or otherwise movable to release pressurized fluid from within the cavity. FIG. 14 illustrates an exemplary fitting assembly 100o that includes an O-ring seal 176o that is wedged or axially squeezed or compressed between a jacket end portion 144o and an installed fitting nut 103o to provide a seal between the jacket end portion 144o and an end face 111o of the fitting nut 103o. The exemplary O-ring seal 176o is sized and/or configured to sufficiently expand to release pressurized fluid disposed within the small cavity between the jacket end portion 44o and the end face 11o of the fitting nut 3o, for example, to prevent the buildup of excessive fluid pressure (e.g., above 1-65 psig) and/or to provide a visual indication of fluid leakage into the cavity.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

We claim:

1. A conduit fitting, comprising:
a conduit connecting device that grips and seals against an unjacketed portion of a metal conduit when the conduit connecting device is assembled on the metal conduit;
a jacket sealing device that can be joined with at least one of the metal conduit and the conduit connecting device to seal against a jacketed portion of the metal conduit to at least partially define a cavity between the conduit connecting device and the jacketed portion of the conduit; and
a venting device configured to move from a sealing position to a venting position to vent pressure in the cavity.

2. The fitting of claim 1, wherein the venting device includes a venting seal member that is movable when under pressure to vent the pressure in the cavity.

3. The fitting of claim 2, wherein the venting seal member is radially expandable to vent the pressure in the cavity.

4. The fitting of claim 2, wherein the venting seal member seats against a vent opening in one of the conduit connecting device, the jacket sealing device, and the venting device.

5. The fitting of claim 1, wherein the conduit connecting device comprises first and second fitting components that can be joined, and at least one conduit gripping device that can grip and seal against the unjacketed portion of the metal conduit when the first and second fitting components are pulled up on the metal conduit.

6. The fitting of claim 5, wherein the first fitting component comprises a fitting body and the second fitting component comprises a fitting nut.

7. The fitting of claim 6, wherein the jacket sealing device comprises a seal engaging member and a sealing element, wherein the sealing element is compressed against an outer surface of the jacketed portion of the metal conduit when the seal engaging member is assembled with the fitting nut.

8. The fitting of claim 7, wherein the seal engaging member comprises a seal nut configured to threadably engage a threaded extension on the fitting nut.

9. The fitting of claim 7, wherein the sealing element comprises an O-ring seal.

10. The fitting of claim 7, wherein the seal engaging member is configured to radially compress the sealing element.

11. The fitting of claim 7, wherein the seal engaging member is configured to axially compress the sealing element.

12. The fitting of claim 6, wherein the venting device comprises an O-ring seal assembled with the fitting nut, the O-ring seal seating against a vent port disposed in the fitting nut and being radially expandable to separate from the vent port in response to pressure in the cavity.

13. The fitting of claim 12, wherein the jacket sealing device comprises a seal nut configured to threadably engage a threaded extension on the fitting nut, and a sealing element that is compressed against an outer surface of the jacketed portion of the metal conduit when the seal nut is fully assembled with the fitting nut.

14. The fitting of claim 13, wherein the O-ring seal is covered by the seal nut when the seal nut is fully assembled with the fitting nut, and the O-ring seal is exposed beyond the seal nut when the seal nut is under-tightened on the fitting nut.

15. The fitting of claim 1, wherein the venting device is configured to vent the pressure in the cavity at a pressure of approximately 1-65 psig.

16. A method for making a mechanical connection to a jacketed metal conduit having an unjacketed portion, comprising the steps of:
attaching a fitting to the unjacketed portion of the metal conduit;
compressing a sealing element in sealing engagement with a jacketed portion of the metal conduit, thereby forming a fluid-tight seal against the jacketed portion to protect the unjacketed portion of the metal conduit, and a cavity at least partially defined by the sealing element; and
effecting a cavity venting seal, such that a pressure in the cavity is vented past the cavity venting seal.

17. The method of claim 16, wherein compressing the sealing element in sealing engagement with the jacketed portion of the metal conduit comprises joining a seal engaging member with the fitting.

18. The method of claim 16, wherein joining the seal engaging member with the fitting comprises threading the seal engaging member onto a threaded extension of a fitting nut of the fitting.

19. The method of claim 16, wherein effecting a cavity venting seal comprises seating a venting seal member against a vent opening in fluid communication with the cavity.

20. The method of claim 19, wherein the vent opening is disposed in a fitting nut of the fitting.

21. The method of claim 16, wherein the pressurize in the cavity is vented past the cavity venting seal at a pressure of approximately 1-65 psig.

22. The method of claim 16, wherein the cavity venting seal provides a seal against ingress of contaminants into the cavity.

23. A conduit fitting assembly, comprising:
a metal conduit having a jacketed portion and an unjacketed portion;
a conduit connecting device assembled on the metal conduit, the conduit connecting device gripping and sealing against the unjacketed portion of the metal conduit;
a jacket seal joined with at least one of the metal conduit and the conduit connecting device to seal against the jacketed portion of the metal conduit;
a cavity between the conduit connecting device and the jacketed portion of the conduit; and
a vent and a vent seal that when under pressure from pressure in the cavity the vent seal moves to a position that vents the pressure in the cavity.

24. A conduit fitting, comprising:
a conduit connecting device that provides a metal connection to an unjacketed portion of a metal conduit when the conduit fitting is assembled on the metal conduit;
a jacket sealing device that seals against a jacketed portion of the metal conduit when the conduit fitting is assembled on the metal conduit,
a venting device that moves from a first position to a venting position to vent pressure in a cavity of the conduit fitting.
